(19) United States
(12) Patent Application Publication
(10) Pub. No.: US 2022/0034436 A1
(43) Pub. Date: Feb. 3, 2022

(54) MULTI-COUPLER MANIFOLD WITH MANUAL AND AUTOMATIC PRESSURE RELIEF

(71) Applicant: Parker-Hannifin Corporation, Cleveland, OH (US)

(72) Inventors: Andrew HOLST, Plymouth, MN (US); Paul LEMAY, Shoreview, MN (US); Timothy MARQUIS, Otsego, MN (US)

(21) Appl. No.: 17/290,334

(22) PCT Filed: Jan. 14, 2020
(86) PCT No.: PCT/US2020/013424

§ 371 Date: Apr. 30, 2021

Related U.S. Application Data
(60) Provisional application No. 62/792,422, filed on Jan. 15, 2019.

(51) Int. Cl. F16L 37/33; F16L 37/56; F16K 15/04; F16K 31/60

(52) U.S. Cl. CPC F16L 37/33; F16L 37/56; E02F 3/3654; F16K 31/60; F16K 15/044

(57) ABSTRACT

A multi-coupling component (20) includes a plurality of fluid couplers (22, 24, 26, 28) that are fluidly connected to a plurality of corresponding fluid flow pathways (80, 84), and a case drain fluid coupler (32) that is fluidly connected to a low pressure drain fluid pathway (88); and a pressure relief mechanism (40) that is configured to be moved between a disconnected state, a partially connected state, and a fully connected state. The pressure relief mechanism is configured such that in the partially connected state the fluid flow pathways and drain fluid pathway are fluidly connected to perform a pressure relief function, and in the disconnected state and the connected state the drain fluid pathway is isolated from the fluid flow pathways. The pressure relief mechanism includes a pressure relief button, wherein the pressure relief button is depressed to move the pressure relief mechanism from the disconnected state to the partially connected state and to the connected state. The pressure relief mechanism may be operated manually by hand for the subsequent connection of individual fluid couplers, or automatically when a second multi-coupling component is attached to the multi-coupling component that has the pressure relief mechanism.

### FIELD OF INVENTION

The present invention relates generally to quick couplings, and more particularly to multi-couplings for connecting multiple fluid lines in high pressure and other fluid systems, such as hydraulic fluid systems.

### BACKGROUND OF THE INVENTION

Quick couplings in general are common devices for coupling fluid lines without the need for special tools. Quick couplings, for example, may be configured as individual couplings for the connection of a single fluid line. An exemplary use of quick couplings is in the connection of hydraulic fluid lines in hydraulic systems. Individual quick couplings typically have a ball locking mechanism to hold two halves of the coupling together as they try to separate from internal pressures. Quick couplings may be configured as either individual couplings or as a multi-coupling for connecting any number of multiple fluid lines.

As an example of a usage of quick couplings, FIG. 1 is a drawing depicting a block diagram of operative portions of an exemplary hydraulic fluid system 10 that may employ embodiments of the present application. This hydraulic fluid system 10 is illustrative of an exemplary auxiliary hydraulic circuit including a coupler manifold 12 that includes a coupling arrangement 14. The coupler arrangement 14 may be a multi-coupling arrangement. A hydraulic pump 16 pumps hydraulic fluid to and from a tank 17, which also may provide a low pressure case drain of flow from the coupler manifold 12, with flow direction dictated under the control of a directional valve 18. Hydraulic fluid passes through the manifold 12 and coupler arrangement 14 for operation of an attachment device 19.

A multi-coupling constitutes a group of quick couplings mounted together in a plate or casting. In place of an individual locking mechanism for each individual coupling, a multi-coupling typically has a multi-line connection and locking mechanism that connects and holds the group of individual couplings together. The mechanical advantage of this single multi-line connection and locking mechanism is often beneficial to overcome the combined forces required to connect all of the quick couplings simultaneously.

An exemplary use of multi-couplings with a multi-line connection mechanism is with mobile equipment, such as for example compact farm tractors and similar equipment or vehicles such as skid steers. Often with such mobile equipment, more than one hydraulic fluid line is needed to run a hydraulic tool or implement, such as a front loader, plow attachment, or the like, which corresponds in FIG. 1 to the attachment device 16. The use of standard individual couplings would require the user to make all connections with multiple different connecting steps. A multi-coupling with a multi-line connection can be connected without having to perform individualized connections for each hydraulic fluid line, which saves time and effort. In addition, a multi-coupling generally prevents a user from connecting the wrong hose on the implement to the wrong coupling port on the piece of equipment such as a base vehicle. In the example of a compact farm tractor or skid steer, different tool implements (e.g., a front loader, plow attachment, etc.) may be mounted to the tractor.

An issue that arises is that a residual pressure may build up or be present on the fixed equipment (machine) side component of the multi-coupling, caused for example by the presence of residual hydraulic fluid in the flow pathways of the fixed coupling component, and particularly due to changes in environmental conditions such as temperature. It is desirable to relieve such pressure when connecting individual fluid lines or a mobile (attachment) side component of a multi-coupling system to the fixed equipment side multi-coupling component.

### SUMMARY OF INVENTION

There is a need in the art, therefore, for an enhanced multi-coupling arrangement that provides effective relief of residual pressure in a fluid flow system, such as a hydraulic fluid system. Embodiments of the present application relate generally to fluidic systems, and more particularly to a quick-connect coupler manifold including a decompression valve assembly for relieving pressure from pressure lines for facilitating coupling of, for example, auxiliary hydraulic system components. The decompression feature can be actuated by hand, or automatically using a multi-coupling configuration for connecting multiple fluid lines simultaneously.

Often, the hydraulic fluid lines will have trapped pressure in them on one or both of the fixed (machine) side and mobile (attachment) side. Special features of the coupling arrangement are needed to relieve the trapped pressure to make a full connection of the hydraulic fluid lines. Embodiments of the present application allow for the connection of a fixed (machine) side multi-coupling component to a mobile (attachment) side multi-coupling component having a plurality of individual couplers. The coupling system, and particularly the fixed side multi-coupler component, has a built-in pressure relief system that relieves all pressurized lines simultaneously for a multi-coupling arrangement. The coupling system also allows for pressure relief manually, such as by hand, when connecting or disconnecting individual couplings to the fixed side multi-coupling component.

An aspect of the invention, therefore, is a multi-coupling component that has an enhanced pressure relief mechanism. In exemplary embodiments, the multi-coupling component includes a plurality of fluid couplers that are fluidly connected to a plurality of corresponding fluid flow pathways, and a case drain fluid coupler that is fluidly connected to a low pressure drain fluid pathway; and a pressure relief mechanism that is configured to be moved between a disconnected state, a partially connected state, and a fully connected state. The pressure relief mechanism is configured such that in the partially connected state the fluid flow pathways and drain fluid pathway are fluidly connected to perform a pressure relief function, and in the disconnected state and the connected state the drain fluid pathway is isolated from the fluid flow pathways.

In exemplary embodiments of the multi-coupling component, the pressure relief mechanism includes a pressure relief button, wherein the pressure relief button is depressed to move the pressure relief mechanism from the disconnected state to the partially connected state and to the connected state. The pressure relief mechanism includes a plurality of ball valves that are operable to isolate the drain fluid pathway from the fluid flow pathways when the pressure relief mechanism is in the disconnected state and the connected state, and the pressure relief mechanism further comprises a plunger connected to the pressure relief button that interacts against the ball valves as the pressure relief mechanism moves between the disconnected state, the partially connected state, and the connected state.

Another aspect of the invention is multi-coupling system that includes a first multi-coupling component according to any of the embodiments, and a plurality of individual fluid couplers that are connectable to a portion of the plurality of fluid couplers and the case drain fluid coupler of the first multi-coupling component. The pressure relief mechanism is operable manually by hand to perform the pressure relief function to permit subsequent connection of the plurality of individual fluid couplers to the first multi-coupling component.

Another aspect of the invention is multi-coupling system that includes a first multi-coupling component according to any of the embodiments, and a second multi-coupling component that is connectable to the first multi-coupling component and comprising a plurality of fluid couplers that are connectable to a portion of the plurality of fluid couplers and to the case drain of the first multi-coupling component. The second multi-coupling includes a driving region that automatically operates the pressure relief mechanism of the first multi-coupling component as the second multi-coupling component is connected to the first multi-coupling component.

These and further features of the present invention will be apparent with reference to the following description and attached drawings. In the description and drawings, particular embodiments of the invention have been disclosed in detail as being indicative of some of the ways i which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting a block diagram of operative portions of an exemplary hydraulic fluid system.

FIG. 2 is a drawing depicting a front view of an exemplary fixed side component of a multi-coupling assembly in accordance with embodiments of the present application.

FIG. 3 is a drawing depicting a rear view of the exemplary fixed side component of a multi-coupling assembly of FIG. 2.

FIG. 4 is a drawing depicting a side view of the exemplary fixed side component of a multi-coupling assembly of FIG. 2, illustrating a portion of the internal fluid pathways.

FIG. 5 is drawing depicting a manual operation of a pressure relief mechanism configured in accordance with embodiments of the present application.

FIG. 6 is a drawing illustrating the coupling of individual fluid couplers to the fixed side component of FIG. 2.

FIG. 7A is a drawing depicting a front view of an exemplary mobile side component of a multi-coupling assembly in accordance with embodiments of the present application.

FIG. 7B is a drawing depicting a rear view of the exemplary mobile side component of a multi-coupling assembly of FIG. 7A.

FIG. 8 is a drawing depicting a multi-coupling assembly including the fixed half coupler component and the mobile half coupler component in isolation, i.e. in a disconnected state.

FIG. 9 is a drawing depicting the multi-coupling assembly including the fixed half coupler component and the mobile half coupler component aligned in a position that is ready for connection.

FIG. 10 is a drawing depicting the multi-coupling assembly including the fixed half coupler component and the mobile half coupler component in a partially connected state.

FIG. 11 is a drawing depicting the multi-coupling assembly including the fixed half coupler component and the mobile half coupler component in a fully connected and operational state.

FIG. 12 is a drawing that summarizes the various pressure states for both the automatic operation using the mobile multi-coupling components, and the manual operation for a hand pressure relief operation when attaching individual couplers.

FIG. 13 is a drawing depicting a cross-sectional view of the exemplary fixed side component of the multi-coupling assembly.

FIG. 14 is a drawing depicting a cross-sectional view of the exemplary multi-coupling assembly in a partially connected state in which pressure relief is performed.

FIG. 15 and FIG. 16 are drawings depicting a cross-sectional view of the exemplary multi-coupling assembly in a fully connected and operational state, and illustrating different pressure conditions.

FIG. 17 is a drawing depicting a cross-sectional view of another exemplary fixed side coupler component for a multi-coupling assembly in accordance with embodiments of the present application.

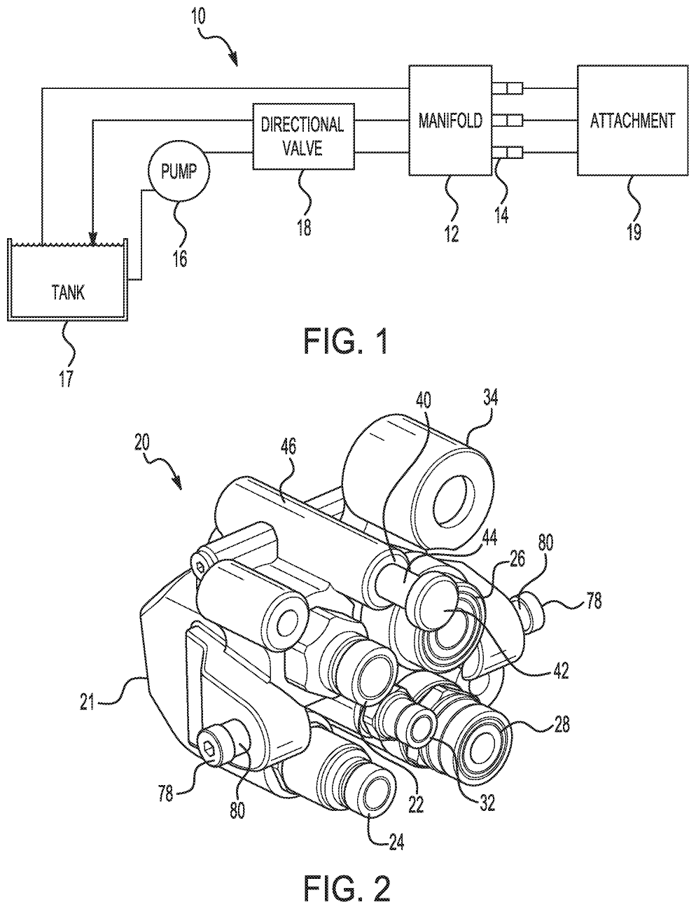

### DETAILED DESCRIPTION

Embodiments of the present application will now be described with reference to the drawings, wherein like reference numerals are used to refer to like elements throughout. It will be understood that the figures are not necessarily to scale.

Embodiments of the present application relate generally to fluidic systems, and more particularly to a quick-connect coupler manifold including a decompression valve assembly for relieving pressure from pressure lines for facilitating coupling of, for example, auxiliary hydraulic system components. The decompression feature can be actuated by hand, or automatically using a multi-coupling configuration for connecting multiple fluid lines simultaneously.

Hydraulic couplings often are used on small construction equipment machines, such as skid steer type loaders and similar compact tractors and like construction equipment, to connect to the lines of auxiliary attachments that may be attached to a main equipment such as a vehicle. Quick-connect couplers are often used to allow quick and convenient connection and disconnection of hydraulic lines of an attachment to the auxiliary hydraulic circuit of the machinery. These types of couplers also are often used on construction equipment or agricultural tractors for connecting auxiliary circuits that power work tools or pull-behind implements. The couplers are frequently housed in valve stacks or banks on the machinery in a position that is easily accessible to the operator when connecting an attachment. As such, the couplers are generally in close proximity to each other. Often, the hydraulic lines will have trapped pressure in them on one or both of the fixed (machine) side and mobile (attachment) side. Special features of the coupling arrangement are needed to relieve the trapped pressure to make a full connection of the hydraulic fluid lines.

Embodiments of the present application, therefore, allow for the connection of a mobile (attachment) side multi-coupling component to a fixed (machine) side multi-coupling component having a plurality of individual fluid couplers. The coupling system, and particularly the fixed side component, has a built-in pressure relief system that relieves all pressurized lines simultaneously for a multi-coupling arrangement. The coupling system also allows for pressure relief manually, by hand, when connecting or disconnecting individual fluid couplings to the fixed side multi-coupling component. Conventional multi-coupling configurations do not allow for both multi-coupling and manual pressure relief operations with respect to the same fixed half multi-coupling component. Embodiments of the present application further permit the convenience of using the larger ¾″ couplers in a multi-coupling configuration while still allowing those same ¾″ couplers to be used on an individual connection, or the connection of the ½″ couplers as an individual connection. Such versatility of connections is not suitable for many conventional multi-coupling configurations.

If a comparable arrangement of coupling system were to be configured with conventional pressure relieving cartridges, which are the current most prevalent technology on skid steers for example, the solution would need to actuate those cartridges and release them prior to full connection with a multi-coupling component. This would be a highly complex and difficult operation to achieve in conventional systems. Accordingly, configurations of the present application provide for an enhanced pressure relief operation for a multiple coupling arrangement as compared to conventional configurations.

FIGS. 2-4 are drawings depicting different views of an exemplary fixed half (machine side) multi-coupling component 20 of a multi-coupling system in accordance with embodiments of the present application. The example of FIGS. 2-4 is illustrative of a fixed half multi-coupling component that is particularly suitable for use in a skid steer, although the principles of the present application more generally may apply to any suitable multi-coupling system. In accordance with standard ISO 16028, the fixed half multi-coupling component 20 has a body 21 that may include or define five individual coupler components, including two alternatively sized (i.e., ISO 16028¾″ and ½″) male coupler components 22 and 24, and two corresponding alternatively sized female coupler components 26 and 28. As illustrated particularly in FIG. 4, which is a side view illustrating a portion of the internal fluid pathways, the male couplers may share a common internal flow path 30 with each other, and the female couplers similarly may include a common internal flow path with each other (the common female fluid flow path is not specifically visible in this side view). In a given connection arrangement, one set of a male and corresponding female coupler components of comparable size are fluidly connected to form a hydraulic circuit. The fixed half component 20 further may include a case drain coupler connection 32, which provides a connection to a low-pressure tank drain, and which also may be a male coupler connection. The fixed half component 20 further may include an electrical connection 34, such as for receiving a 14-pin electrical socket, that is connectable to a suitable power source.

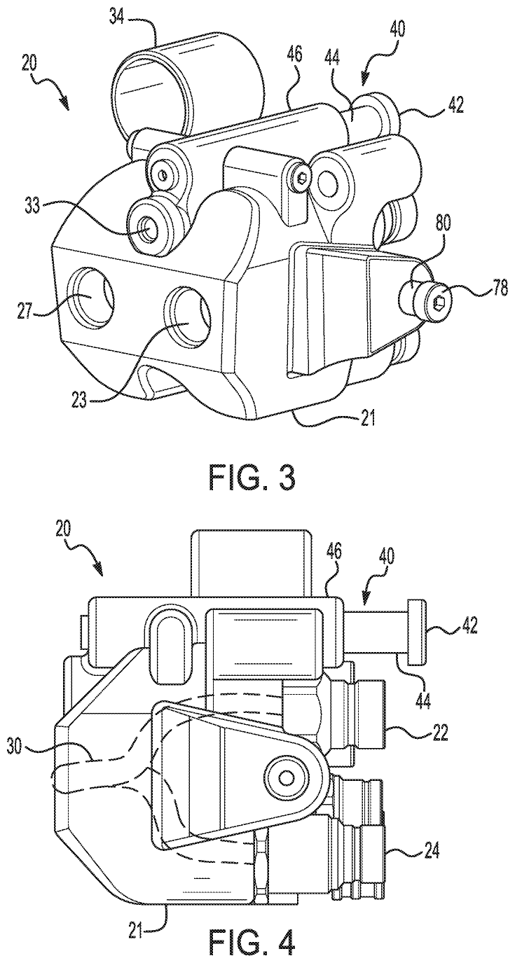

FIG. 2 illustrates a front-view of such features, which face and are connectable to a mobile (attachment) side component as described in more detail below, and FIG. 3 illustrates a rear view of such components illustrating the ports through the manifold that is formed by the body 21. In particular, as shown in the rear view of FIG. 3 the body 21 may include or define a first common port 23 that constitutes a common port for the male couplers 22 and 24, and a second common port 27 that constitutes a common port for the female couplers 26 and 28. The body 21 further may include or define a case drain port 33 for the case drain coupler 32, which ultimately is connected to a fluid tank (not shown).

The fixed half multi-coupling component 20 further may include a pressure relief mechanism 40 that is operative to relieve a pressure build-up in the fixed have multi-coupling component 20. In exemplary embodiments, the pressure relief mechanism includes a pressure relief push button 42 that is fixed to a plunger 44. The plunger 44 is movable, such as by sliding, within a tube 46 that is part of the body 21 of the fixed half component 20. Accordingly, the pressure relief mechanism 40 is operable between a first state in which the pressure relief mechanism 40 is extended relative to the tube 46, and a second state in which the pressure relief mechanism 40 is encompassed generally within the tube 46 as compared to the first state. As further detailed below, the pressure relief mechanism 40 may be operated either manually such as by hand, which is suitable for connecting individual fluid couplers, or automatically upon connecting a mobile side multi-coupling component.

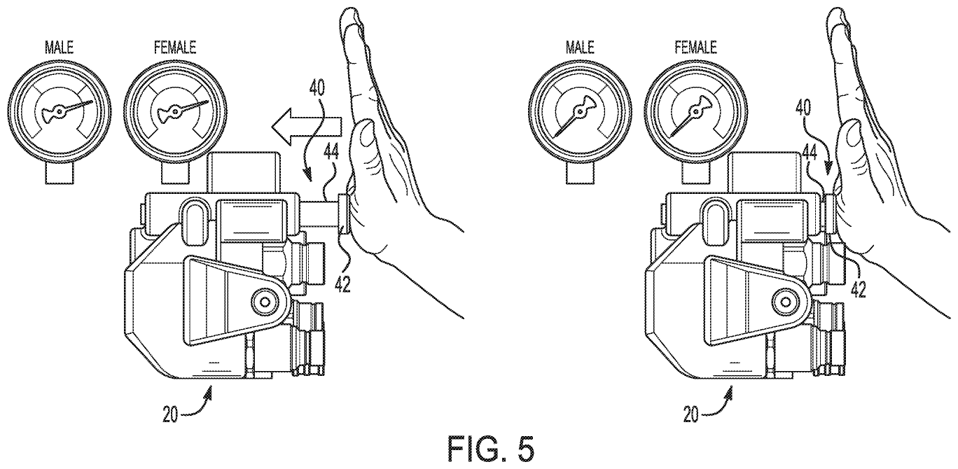

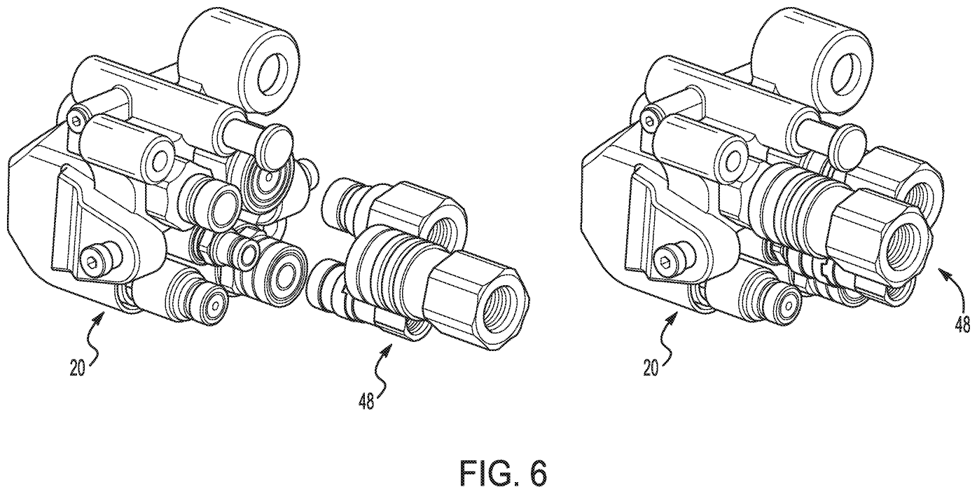

FIG. 5 is drawing depicting a manual operation of the pressure relief mechanism 40 configured in accordance with embodiments of the present application. FIG. 6 is a drawing illustrating the coupling of individual fluid couplers 48 to the fixed side multi-coupling component. The left portion of FIG. 5 illustrates the pressure relief mechanism 40 in the first state in which the pressure relief mechanism is relatively extended from the tube 46. In this first state, as illustrated by the pressure gauge indications of the left portion of FIG. 5, a high pressure build-up may be present in one or both of the male and female couplers of the fixed side component 20. As referenced above, the high pressure build-up may be caused, for example, by the presence of residual hydraulic fluid in the flow pathways of the fixed coupling component 20, particularly due to changes in environmental conditions such as temperature.

The right portion of FIG. 5 illustrates the pressure relief mechanism 40 in the second state in which the pressure relief mechanism is relatively encompassed within the tube 46 as compared to the first state. In a manual operation, the transition from the first state to the second state is performed by manually depressing, such as by hand, the push button 42 of the pressure relief mechanism 40 in the direction indicated by the arrow in FIG. 5. Depressing the push button 42 imparts movement to the plunger 44 by which the plunger 44 slides within the tube 46. In the second state, as illustrated by the pressure gauge indications of the right portion of FIG. 5, the high pressure build-up has been relieved from the male and female couplers of the fixed side component 20. Once the pressure has been relieved in this manner, individual fluid couplers 48 may be connected to corresponding male and/or female couplers on the fixed side component 20. For example, the left portion of FIG. 6 illustrates the individual fluid couplers 48 disconnected from the couplers of the fixed side component 20, and the right portion of FIG. 6 illustrates the individual fluid couplers 48 connected to complementary couplers of the fixed side component 20. In the depicted example, the individual fluid couplers 48 are loose ISO 16028 couplers that correspond to complementary ISO 16028 couplers on the fixed side component 20.

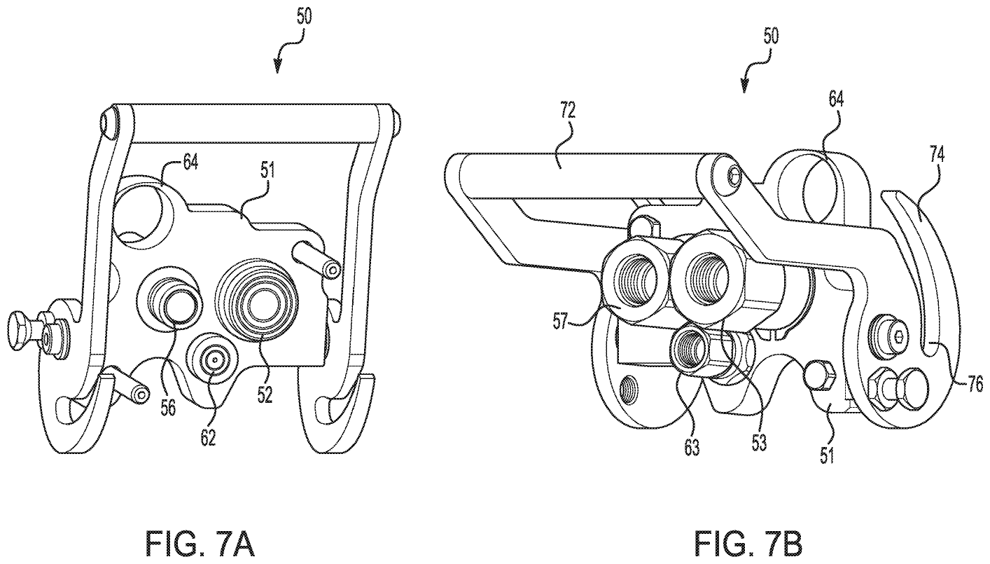

FIGS. 7A and 7B are drawings depicting different views of an exemplary mobile half (attachment side) multi-coupling component 50 of a multi-coupling assembly in accordance with embodiments of the present application. The mobile side component 50 is configured for joining with the fixed side component 20 for communicating fluid between the fixed side (e.g., machine or vehicle) and the attachment side (e.g., attachment implement such as front loader, plow attachment). The mobile half multi-coupling component 50 includes couplings that couple with a portion of the couplings of the fixed half multi-coupling component, in particular to one of the male/female coupling pairs and to the case drain. One of the couplings on the mobile half multi-coupling component may be a pressure relieving coupling, such as the male mobile half coupler, that manages pressure within the multi-coupling assembly during use.

Accordingly, the mobile half multi-coupling component 50 has a body 51 that may include or define at least one female component 52 of one of the two alternative sizes (e.g., ISO 16028 ¾″ or ½″) that can connect with at least one of the male coupler components 22 or 24 on the fixed side, and at least one male component 56 of one of the two alternative sizes that can connect with one of the female coupler components 26 and 28 on the fixed side. In a given connection arrangement, therefore, one set of a male and corresponding female coupler components of comparable size are fluidly connected to form a hydraulic circuit. The mobile half component 50 further may include a case drain coupler connection 62, which provides a connection to the low-pressure case drain coupler 32 on the fixed side, and which also may be a female coupler connection. The mobile half component 50 further may include an electrical connection socket 64 that is aligned to the electrical connection 34 on the fixed side.

FIG. 7A illustrates a front-view of such features, which face and are connectable to the fixed (machine) side component, and FIG. 7B illustrates a rear view of such components illustrating the fittings for connecting to fluid transmission components (e.g., hoses) that are connected to the body 51. In particular, as shown in the rear view of FIG. 7B the fittings may include a first fitting 53 that provides a fluid connection for flow in a forward direction (e.g., from the fixed side to the mobile side), and a second a second fitting 57 that provides a fluid connection for flow in a return direction (e.g., from the mobile side to the fixed side). Either fitting may be associated with the forward or return flow, and vice versa. The body 21 further may include or define a case drain fitting 63 that provides a fluid connection for the case drain flow that is connected to a fluid tank (not shown).

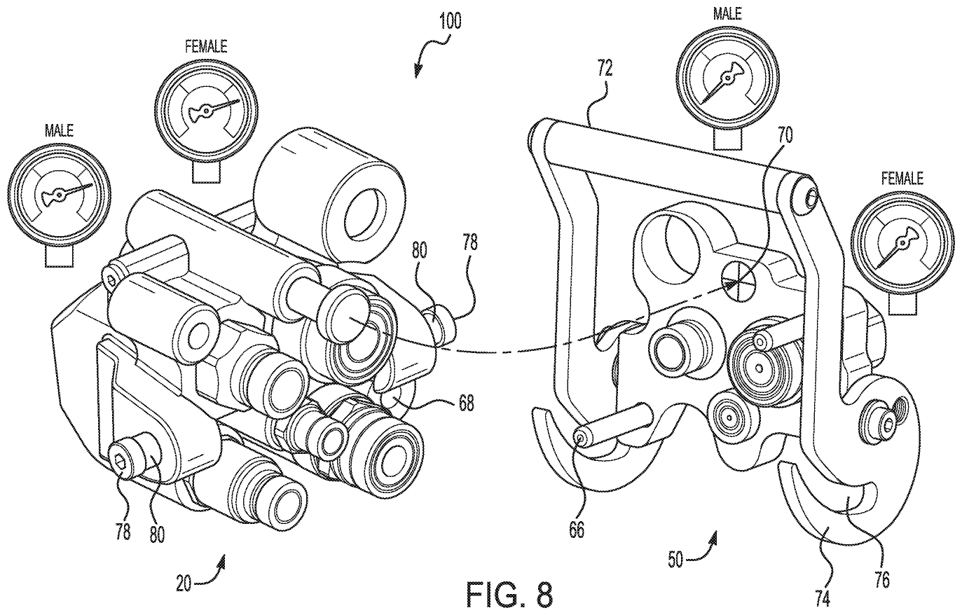

FIGS. 8-11 are drawings illustrating operation of the pressure relief mechanism for use with a multi-coupling assembly 100 including the fixed half and mobile half multi-coupling components of the previous figures. FIG. 8 is a drawing illustrating a multi-coupling assembly 100 including the fixed half coupler component 20 and the mobile half coupler component 50 in isolation, i.e. in a disconnected state. To align the components together for connection, in this example the mobile side coupler component 50 includes an alignment pin 66 that aligns with a corresponding alignment hole 68 on the fixed side coupler component, although any suitable alignment mechanism may be employed. The body 51 of the mobile side coupler component 50 further includes a driving region 70 that constitutes a driving surface that operates to act on the pressure relief mechanism 40 of the fixed side coupler component 20, as further detailed below. As illustrated by the pressure gauge depictions in FIG. 8, in this initial disconnected state there may be residual pressure build-up in either or both of the male/female couplers, and with respect to either or both of the fixed side coupler component and the mobile side coupler component.

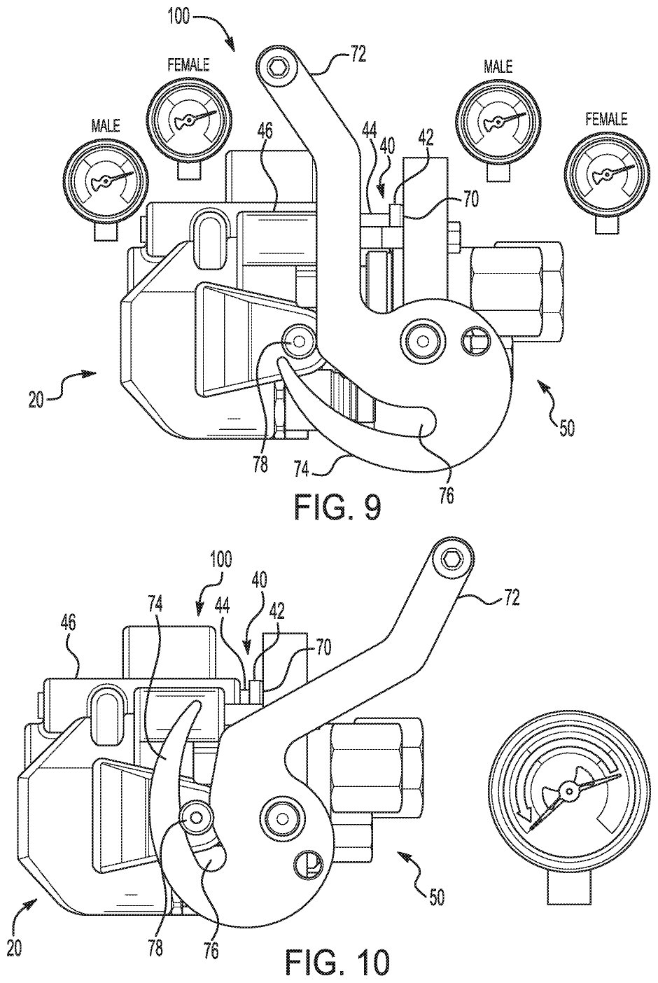

FIG. 9 is a drawing illustrating the multi-coupling assembly 100 including the fixed half coupler component 20 and the mobile half coupler component 50 aligned in a position that is ready for connection. Again, as an example alignment mechanism the alignment pin 66 on the mobile coupler component side may be aligned with and inserted into the alignment hole on the fixed side coupler component (see FIG. 8). Although aligned, in the ready state of FIG. 9 the coupler components remain in a disconnected state, and thus as indicated by the illustrative pressure gauges, a pressure build-up still may be retained in one or both of the coupler components. In this ready state, the driving region 70 on the mobile coupler component side is aligned with the pressure relief mechanism 40 on the fixed coupler component side. In particular, the surface that constitutes the driving region 70 on the mobile coupler component side is aligned with the push button 42 of the pressure relief mechanism 40 on the fixed coupler component side.

The mobile side coupler component 50 further includes a handle 72 and one or more (two in this example) arms 74 that define locking slots 76. In addition, the fixed side coupler component 20 further includes one or more (two in this example) corresponding lugs 78 that define locking recesses 80. From the ready state of FIG. 9, coupling is achieved by a user operating the handle 72 on the mobile side coupler component half to pull the two half coupler components together. In particular, as the handle is rotated, each arm 74 with locking slot 76 interacts with a corresponding lug 78 with locking recess 80 (see also FIGS. 2-3, 8). The locking recesses 80 slide within the corresponding locking slots 76, and the curved nature of the arms/slots results in a cam interaction that pulls the two half coupler components together.

FIG. 10 is a drawing illustrating the multi-coupling assembly 100 including the fixed half coupler component 20 and the mobile half coupler component 50 in a partially connected state. In the partially connected state, the pressure relief button 42 of the pressure relief mechanism 40 is partially depressed by the driving region 70 of the mobile side coupler component 50 (as identified in FIG. 8). In this manner, the mobile coupler component automatically acts to depress the pressure relief button as the two coupler halves are being connected. As referenced above in connection with FIG. 5, similarly as in the manual pressure relief operation, depressing the push button 42 imparts movement to the plunger 44 by which the plunger 44 slides within the tube 46 of the fixed side coupler component 20. In such partially depressed state, as illustrated by the representative pressure gauge in FIG. 10, any excess pressure that has built up within the coupler components is relieved.

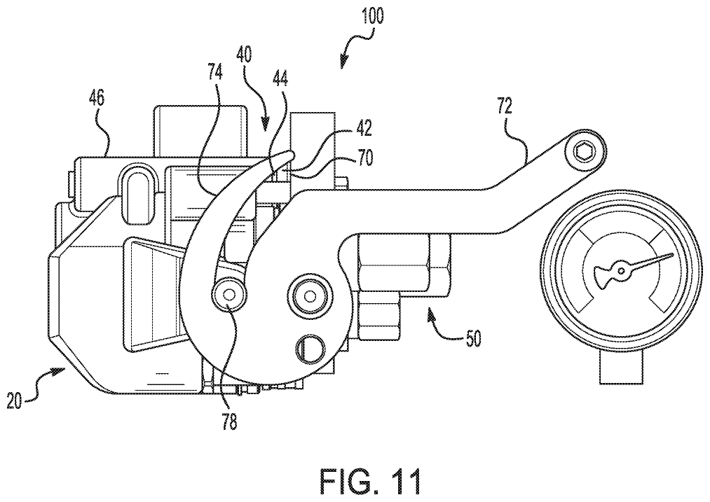

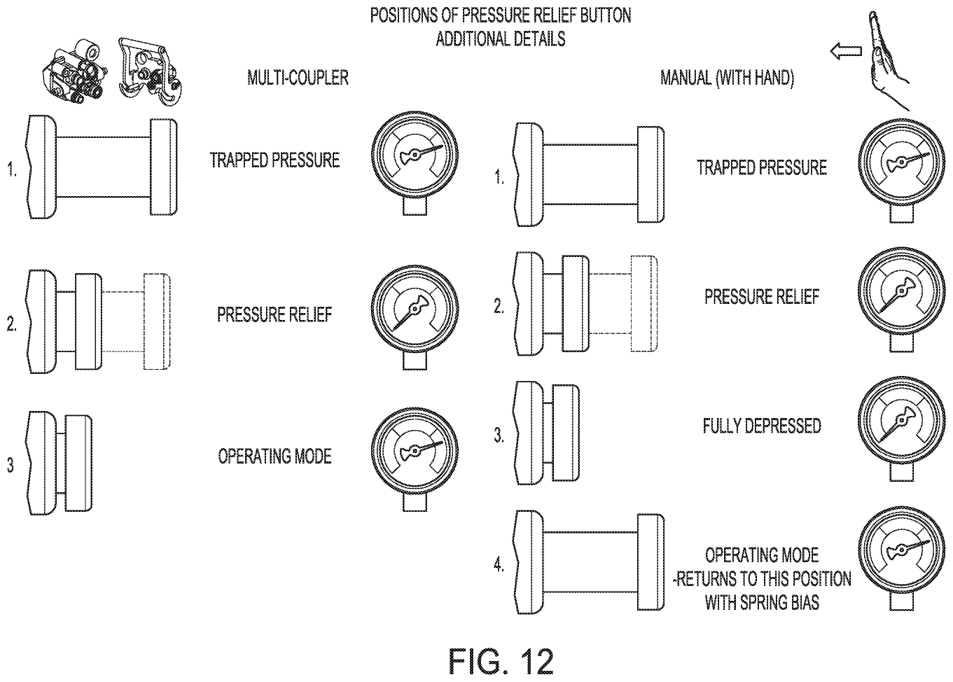

FIG. 11 is a drawing illustrating the multi-coupling assembly 100 including the fixed half coupler component 20 and the mobile half coupler component 50 in a fully connected and operational state. The fully connected state corresponds to hydraulic functionality, and thus as indicated by the representative pressure gauge in FIG. 11, such state permits the maintenance of high pressure within the multi-coupling components for operation of the hydraulic circuit. In terms of operation of the pressure relief mechanism 40, in the fully connected state of FIG. 11 the driving region 70 has depressed the push button 42 in a maximum amount that is depressed farther relative to the pressure relief/partially connected state of FIG. 10. In this fully connected state, the position of the pressure relief mechanism 40 is such that the pressure relief mechanism no longer relieves the pressure, but rather permits maintenance of high pressure for operation of the hydraulic circuit.

FIG. 12 is a drawing that summarizes the various pressure states for both the automatic operation using the mobile multi-coupling component, and the manual operation for a hand pressure relief operation when attaching individual fluid couplers. As referenced above, when the pressure relief mechanism is in the fully extended position corresponding to a disconnected state (Position 1), trapped pressure may be maintained within the multi-coupling component(s). In the partially depressed state (Position 2), pressure is relieved from the multi-coupling component(s). In the automatic pressure relief operation using a mobile multi-coupling component, as referenced above the fully connected state (Position 3) corresponds to an operating mode in which a high internal pressure is maintained. In the manual hand operation using the individual fluid couplers, following full depression (Position 3), the pressure relief mechanism retracts back to the extended state (Position 4) under a spring bias, and in such state (similarly as in the disconnected state of Position 1) high pressure is maintained to permit an operating mode using individual couplers.

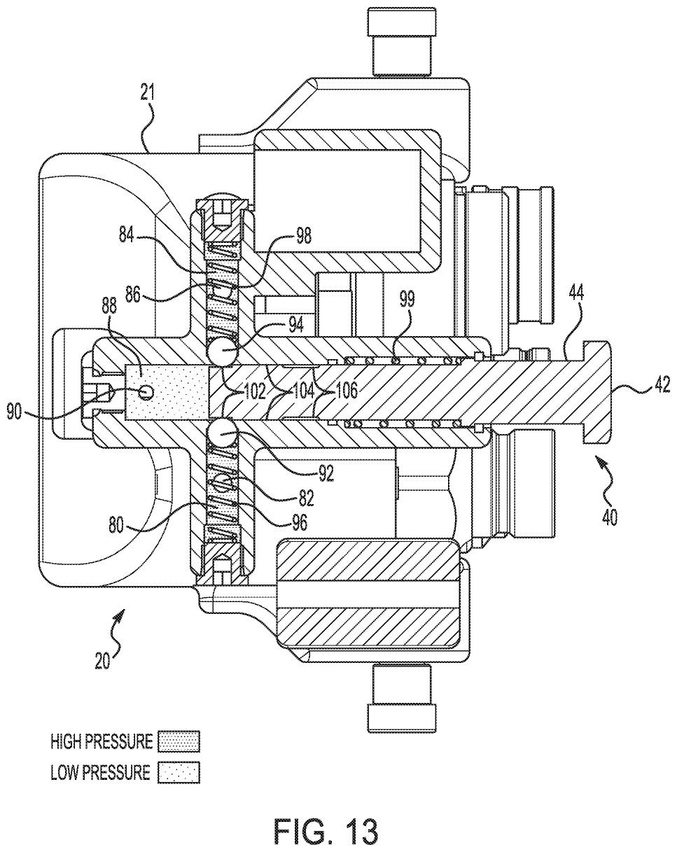

FIGS. 13-16 are cross-sectional diagrams showing operation of the pressure relief mechanism. FIG. 13 is a drawing depicting a cross-sectional view of the exemplary fixed side coupler component 20 of the multi-coupling assembly. As illustrated in this figure, internally the fixed side coupler component 20 includes a male fluid pathway 80 in fluid communication with the male coupler components 22/24 that terminates in a first port 82. Similarly, internally the fixed side coupler component 20 includes a female fluid pathway 84 in fluid communication with the female coupler components 26/28 that terminates in a second port 86. In addition, internally the fixed side coupler component 20 includes a drain fluid pathway 88 in fluid communication with the case drain 32 that terminates in a drain port 90. In FIG. 13, the pressure relief mechanism 40 also is shown, which includes the push button 42 that is operable to move the plunger 44 through the body of the fixed side coupler component 20. Also internally, the fixed side coupler component 20 further includes a first ball valve 92 associated with the male fluid pathway 80, and a second ball valve 94 associated with the female fluid pathway 84. The first ball valve 92 is biased against the plunger 44 by a first valve spring 96, and the second ball valve 94 is biased against the plunger 44 by a second valve spring 98. In this exemplary embodiment, the fixed side coupler component 20 further includes a return spring 99 that biases the pressure relief mechanism 40 in the extended position.

As shown in FIG. 13, which illustrates the fixed side coupler component 20 in a disconnected state comparably as in FIGS. 8 and 9, the first and second ball valves 92 and 94 are forced under pressure and the spring bias into a closed position against an internal valve seat surface 102 that is a portion of an outer surface of an internal end of the plunger 44. With the ball valves forced into the closed position against the valve seat surface 102, pressure is permitted to build up and be maintained in the fluid flow pathways 80 and 84 of the male and female couplers because such fluid pathways are isolated from the low-pressure case drain fluid pathway 88. In such state, therefore, the case drain is isolated from the male and female fluid flow pathways, and thus the case drain pressure is maintained at a lower pressure relative to the high pressure inside the fluid pathways 80 and 84.

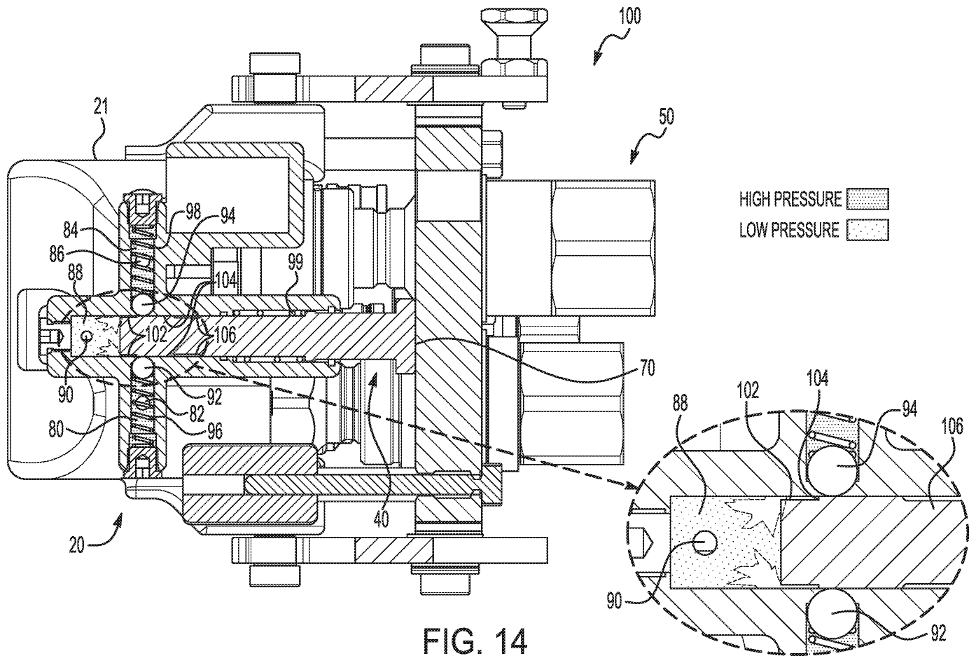

FIG. 14 is a drawing depicting a cross-sectional view of the exemplary multi-coupling assembly 100 in a partially connected state in which pressure relief is performed, comparably as depicted in FIG. 10. FIG. 14 thus shows the partially connected state in which the pressure relief mechanism is partially depressed. As referenced above, in the disconnected state of FIG. 13, the ball valves 92 and 94 are forced against the valve seat surface 102 that is a portion of an outer surface of an internal end of the plunger 44. Adjacent to the valve seat surface 102 in a direction toward the push button 42, the plunger further includes a ramped surface 104 at which the plunger 44 has a wider diameter or width relative to the valve seat surface 102. Such features are more readily shown in the close-up portion of FIG. 14. When the pressure relief mechanism 40 is depressed to the extent of the partially connected state, the plunger ramp surface 104 operates to move the ball valves 92 and 94 out from the closed position against the valve seat surface 102 to an open position against said ramp surface 104. Such movement of the ball valves opens up the fluid pathways 80 and 84 at high pressure to the low-pressure case drain pathway 88 to perform the pressure relief function. In this manner, any high-pressure build-up in the fluid pathways 80 and 84 is relieved by fluid connection to the low-pressure case drain fluid pathway 88.

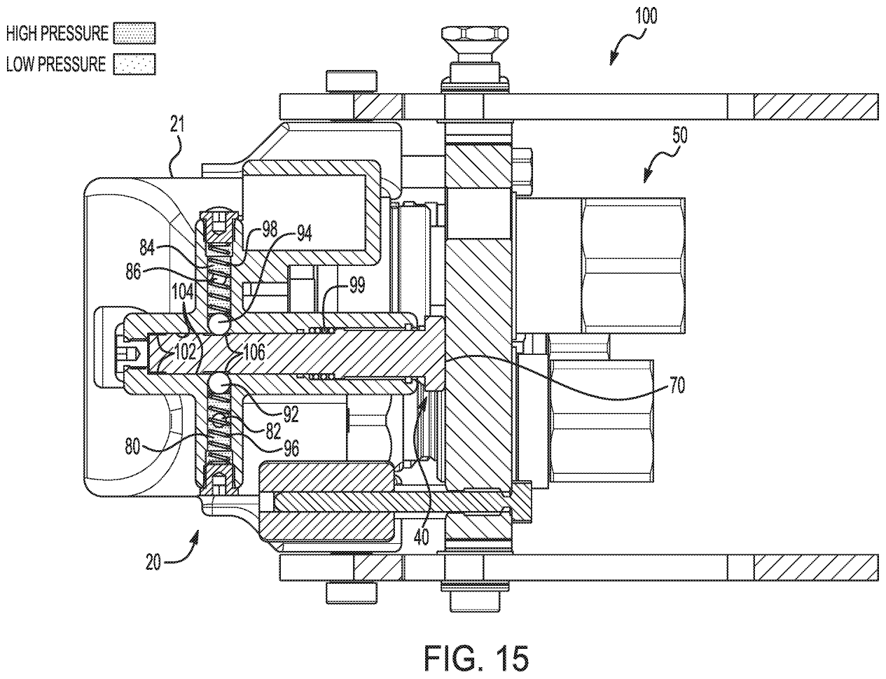

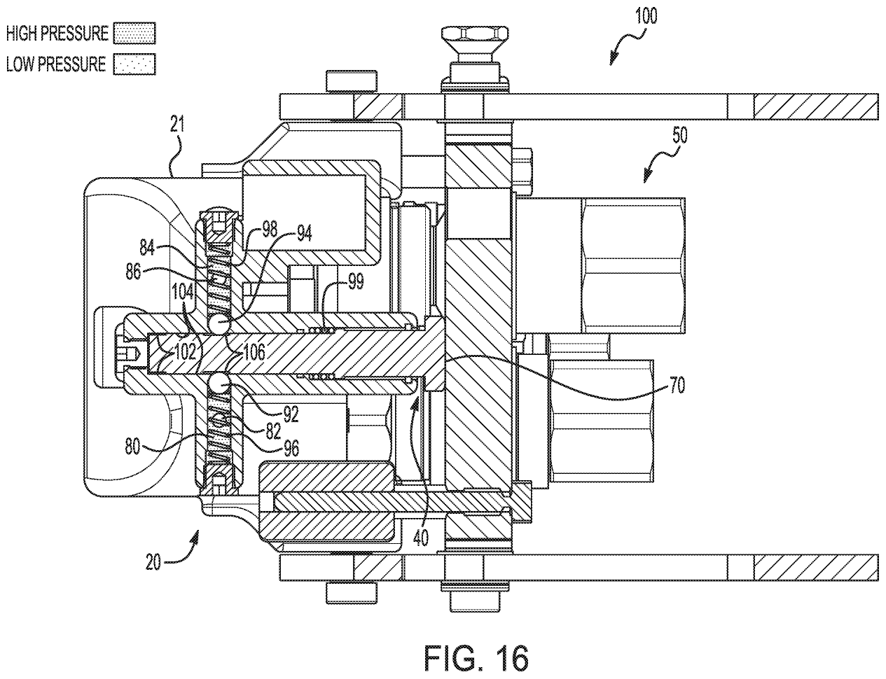

FIG. 15 and FIG. 16 are drawings depicting a cross-sectional view of the exemplary multi-coupling assembly 100 in a fully connected and operational state comparably as depicted in FIG. 11, and illustrating different pressure conditions. FIGS. 15 and 16 thus illustrate the operating mode of the multi-coupling assembly 100. Adjacent to the ramped surface 104 in a direction toward the push button 42, the plunger 44 further includes a recessed surface 106 at which the plunger 44 has a lesser diameter or width relative to the widest portion of the ramped surface 104, and a diameter or width that is comparable to the valve seat surface 102. With the recessed portion 106, in the fully connected state the ball valves 92 and 94 are forced from the open position back to the closed positioned against the recessed surface 106 (similarly as in the initial closed position against the valve seat surface 102) to isolate the case drain pathway 88 from the flow pathways 80 and 84. Initially upon full connection, as shown in FIG. 15, the pressure in the fluid pathways is at the low pressure of the case drain. As shown in FIG. 16, as operation proceeds pressure then builds up and is maintained in the fluid pathways 80 and 84, insofar as such fluid pathways are now isolated from the case drain. In this manner, an operating pressure of hydraulic fluid flow can be achieved and maintained for operation in the operating mode.

In the case of a manual or hand operation as described above, after pressure relief (or full depression of the pressure relief mechanism), a user releases the push button 42 thereby removing the depressive force. Upon such release, the return spring 99 forces the pressure relief mechanism back into the extended position as illustrated in FIG. 13. A user then may connect individual fluid couplers to the fixed side coupler component as described above, rather than a multi-coupling component. In the state of FIG. 13, the ball valves 92 and 94 are forced back into the closed position against the valve seat surface 102, which permits the maintenance of high pressure in the fluid pathways 80 and 84 for operation using individual fluid couplers.

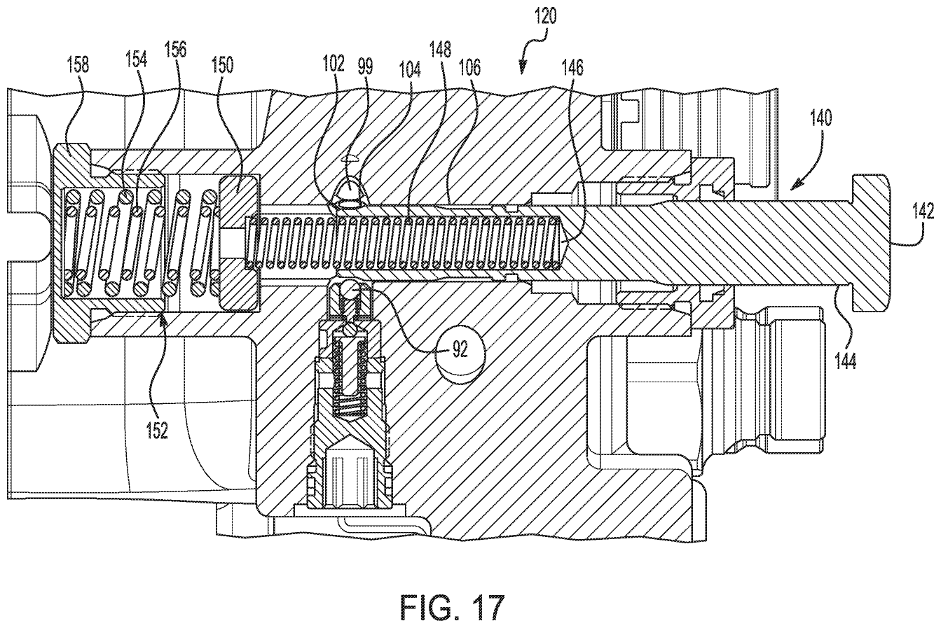

FIG. 17 is a drawing depicting a cross-sectional view of another exemplary fixed side coupler component 120 for a multi-coupling assembly in accordance with embodiments of the present application. The embodiment is FIG. 17 operates comparably to previous embodiments, with a principal difference being the components that control movement of the pressure relief mechanism. Similarly as in previous embodiments, a pressure relief mechanism 140 includes a push button 142 that is operable to drive a plunger 144. In this embodiment, the plunger 144 includes a bore 146 that houses an internal spring 148 that is located partially within the bore. In particular, the internal spring 148 includes a first end that is located within the bore 146, and a second end that is anchored within a spring retainer 150. The body of the fixed side coupler component 120 further houses a backside spring assembly 152 that is located internally relative to the spring retainer, wherein a spring bias of the backside spring assembly 152 is greater than a spring bias of the internal spring 148. In the depicted example, the backside spring assembly 152 includes a first back spring 154 and a second back spring 156 that are housed within a spring housing 158. Two springs 154 and 156 are used in this example to provide a suitable spring force, although other spring configurations may be employed to achieve such suitable spring force.

The pressure relief mechanism of FIG. 17 operates in two-stages. In a first stage, either manually by hand or as part of a multi-coupling connection, the push button 142 is depressed thereby driving the plunger 144 inward similarly as in previous embodiments. This causes the internal spring 148 to compress within the plunger bore 146 against spring retainer 150. As the plunger 144 is driven inward and the internal spring 148 is compressed, the ball valves 92 and 94 are driven from the closed position (FIG. 17 illustrates the closed position) to the open position as detailed above in connection with FIG. 14, whereby the ball valves are moved out from the valve seat surface 102 by the driving action of the ramped surface 104. In this first stage, the spring retainer 150 essentially remains in place, as the force of compressing the internal spring 148 initially is insufficient to move the spring retainer 150 against the opposing force of the backside spring assembly 152. Furthermore, a manual by hand operation of the pressure relief mechanism 140 tends to generate insufficient force to move the spring retainer 150 against the opposing force of the backside spring assembly 152, and thus a manual by hand operation tends to be limited to this first stage. As additional illustration, referring back to FIG. 12, using the embodiment of FIG. 17 the fully depressed state (Position 3) for manual operation would not be achieved, and after the pressure relief state of partial connection (Position 2), the pressure relief mechanism will revert back to the extended operating mode (Position 4) under the bias of the internal spring 148.

In a second stage in which a mobile side component is being attached to the fixed side component for a multi-coupling arrangement, the push button 142 is depressed further thereby driving the plunger 144 further inward against the backside spring assembly 152. Under such action, the spring retainer 150 compresses the back springs 154 and 156 within the spring housing 158. In contrast to manual by hand operation, because of the higher mechanical advantage that is achieved using a multi-coupling connection mechanism, the second stage is thus achievable. As additional illustration, referring back to FIG. 12, using the embodiment of FIG. 17 the fully depressed state (Position 3) for the operating mode of the multi-coupling is achieved. At such state, the ball valves 92 and 94 would be positioned within the recessed surface 106 as also illustrated in FIGS. 15 and 16. Upon disconnection of the mobile side component from the fixed side component, the pressure relief mechanism will revert back to the extended disconnected position under the bias of the backside spring assembly 152 and the internal spring 148.

An aspect of the invention, therefore, is a multi-coupling component that has an enhanced pressure relief mechanism. In exemplary embodiments, the multi-coupling component includes a plurality of fluid couplers that are fluidly connected to a plurality of corresponding fluid flow pathways, and a case drain fluid coupler that is fluidly connected to a low pressure drain fluid pathway; and a pressure relief mechanism that is configured to be moved between a disconnected state, a partially connected state, and a fully connected state. The pressure relief mechanism is configured such that in the partially connected state the fluid flow pathways and drain fluid pathway are fluidly connected to perform a pressure relief function, and in the disconnected state and the connected state the drain fluid pathway is isolated from the fluid flow pathways. The multi-coupling component may include one or more of the following features, either individually or in combination.

In an exemplary embodiment of the multi-coupling component, the pressure relief mechanism comprises a pressure relief button, wherein the pressure relief button is depressed to move the pressure relief mechanism from the disconnected state to the partially connected state and to the connected state.

In an exemplary embodiment of the multi-coupling component, the multi-coupling component further includes a plurality of ball valves that isolate the drain fluid pathway from the fluid flow pathways when the pressure relief mechanism is in the disconnected state and the connected state; and the pressure relief mechanism further comprises a plunger connected to the pressure relief button that interacts against the ball valves as the pressure relief mechanism moves between the disconnected state, the partially connected state, and the connected state.

In an exemplary embodiment of the multi-coupling component, the plunger includes a valve seat surface, and a ramped surface that is located in a direction toward the pressure relief button relative to the valve seat surface, wherein the ramped surface moves the ball valves from a closed position against the valve seat surface to an open position against the ramped surface to fluidly connect the fluid flow pathways and the drain fluid pathway when the pressure relief mechanism is in the partially connected state.

In an exemplary embodiment of the multi-coupling component, the plunger further includes a recessed surface that is located in a direction toward the pressure relief button relative to the ramped surface, and the recessed surface permits the ball valves to move from the open position to a closed position against the recessed surface to isolate the drain fluid pathway from the fluid flow pathways when the pressure relief mechanism is in the fully connected state.

In an exemplary embodiment of the multi-coupling component, the ball valves are biased in a direction toward the plunger.

In an exemplary embodiment of the multi-coupling component, the pressure relief mechanism includes a spring component that biases the pressure relief mechanism toward the disconnected state.

In an exemplary embodiment of the multi-coupling component, the spring component comprises a return spring located along an outer surface of a plunger of the pressure relief mechanism.

In an exemplary embodiment of the multi-coupling component, the spring component comprises: an internal spring located partially within a bore defined by a plunger of the pressure relief mechanism; a spring retainer, wherein a first end of the internal spring is located within the bore and a second end of the internal spring is anchored in the spring retainer; and a backside spring assembly located internally relative to the spring retainer, wherein a spring bias of the backside spring assembly is greater than a spring bias of the internal spring.

In an exemplary embodiment of the multi-coupling component, the backside spring assembly comprises a first back spring and a second back spring that are housed within a spring housing.

In an exemplary embodiment of the multi-coupling component, the plurality of fluid couplers includes a plurality of male fluid couplers and a plurality of female fluid couplers, and the plurality of male fluid couplers are fluidly connected to a common first internal flow pathway and the plurality of female fluid couplers are fluidly connected to a common second internal fluid flow pathway.

In an exemplary embodiment of the multi-coupling component, the multi-coupling component further includes a first ball valve that isolates the drain fluid pathway from the common first internal flow pathway when the pressure relief mechanism is in the disconnected state and the connected state; and a second ball valve that isolates the drain fluid pathway from the common second internal flow pathway when the pressure relief mechanism is in the disconnected state and the connected state. The pressure relief mechanism further includes a plunger connected to the pressure relief button that interacts against the first and second ball valves as the pressure relief mechanism moves between the disconnected state, the partially connected state, and the connected state.

In an exemplary embodiment of the multi-coupling component, the plurality of fluid couplers are standard ISO 16028 fluid couplers.

Another aspect of the invention is multi-coupling system that includes a first multi-coupling component according to any of the embodiments, and a plurality of individual fluid couplers that are connectable to a portion of the plurality of fluid couplers and the case drain fluid coupler of the first multi-coupling component. The pressure relief mechanism is operable manually by hand to perform the pressure relief function to permit subsequent connection of the plurality of individual fluid couplers to the first multi-coupling component.

Another aspect of the invention is multi-coupling system that includes a first multi-coupling component according to any of the embodiments, and a second multi-coupling component that is connectable to the first multi-coupling component and comprising a plurality of fluid couplers that are connectable to a portion of the plurality of fluid couplers and to the case drain of the first multi-coupling component. The second multi-coupling includes a driving region that automatically operates the pressure relief mechanism of the first multi-coupling component as the second multi-coupling component is connected to the first multi-coupling component.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A multi-coupling component comprising:
a plurality of fluid couplers that are fluidly connected to a plurality of corresponding fluid flow pathways, and a case drain fluid coupler that is fluidly connected to a low pressure drain fluid pathway; and
a pressure relief mechanism that is configured to be moved between a disconnected state, a partially connected state, and a fully connected state;
wherein the pressure relief mechanism is configured such that in the partially connected state the fluid flow pathways and drain fluid pathway are fluidly connected to perform a pressure relief function, and in the disconnected state and the connected state the drain fluid pathway is isolated from the fluid flow pathways;
wherein:
the pressure relief mechanism comprises a pressure relief button, and the pressure relief button is depressed to move the pressure relief mechanism from the disconnected state to the partially connected state and to the connected state;
the pressure relief mechanism is operable manually by hand when connecting a plurality of individual fluid couplers to a portion of the plurality of fluid couplers and the case drain fluid coupler of the first multi-coupling component to perform the pressure relief function to permit connecting the plurality of individual fluid couplers to the first multi-coupling component; and
the pressure relieve mechanism is operable automatically by a driving region of a second multi-coupling component when connecting the second multi-coupling component to the first multi-coupling component to perform the pressure relief function, the second multi-coupling component comprising a plurality of fluid couplers that are connectable to a portion of the plurality of fluid couplers and to the case drain of the first multi-coupling component.

2. The multi-coupling component of claim 1, further comprising a plurality of ball valves that isolate the drain fluid pathway from the fluid flow pathways when the pressure relief mechanism is in the disconnected state and the connected state; and
the pressure relief mechanism further comprises a plunger connected to the pressure relief button that interacts against the ball valves as the pressure relief mechanism moves between the disconnected state, the partially connected state, and the connected state.

3. The multi-coupling component of claim 2, wherein the plunger includes a valve seat surface, and a ramped surface that is located in a direction toward the pressure relief button relative to the valve seat surface, wherein the ramped surface moves the ball valves from a closed position against the valve seat surface to an open position against the ramped surface to fluidly connect the fluid flow pathways and the drain fluid pathway when the pressure relief mechanism is in the partially connected state.

4. The multi-coupling of claim 3, wherein the plunger further includes a recessed surface that is located in a direction toward the pressure relief button relative to the ramped surface, and the recessed surface permits the ball valves to move from the open position to a closed position against the recessed surface to isolate the drain fluid pathway from the fluid flow pathways when the pressure relief mechanism is in the fully connected state.

5. The multi-coupling component of claim 2, wherein the ball valves are biased in a direction toward the plunger.

6. The multi-coupling component of claim 1, wherein the pressure relief mechanism includes a spring component that biases the pressure relief mechanism toward the disconnected state.

7. The multi-coupling component of claim 6, wherein the spring component comprises a return spring located along an outer surface of a plunger of the pressure relief mechanism.

8. The multi-coupling component of claim 6, wherein the spring component comprises:
an internal spring located partially within a bore defined by a plunger of the pressure relief mechanism;
a spring retainer, wherein a first end of the internal spring is located within the bore and a second end of the internal spring is anchored in the spring retainer; and
a backside spring assembly located internally relative to the spring retainer, wherein a spring bias of the backside spring assembly is greater than a spring bias of the internal spring.

9. The multi-coupling component of claim 8, wherein the backside spring assembly comprises a first back spring and a second back spring that are housed within a spring housing.

10. The multi-coupling component of claim 1, wherein the plurality of fluid couplers includes a plurality of male fluid couplers and a plurality of female fluid couplers, and the plurality of male fluid couplers are fluidly connected to a common first internal flow pathway and the plurality of female fluid couplers are fluidly connected to a common second internal fluid flow pathway.

11. The multi-coupling component of claim 10, further comprising:
a first ball valve that isolates the drain fluid pathway from the common first internal flow pathway when the pressure relief mechanism is in the disconnected state and the connected state; and
a second ball valve that isolates the drain fluid pathway from the common second internal flow pathway when the pressure relief mechanism is in the disconnected state and the connected state;
wherein the pressure relief mechanism further comprises a plunger connected to the pressure relief button that interacts against the first and second ball valves as the pressure relief mechanism moves between the disconnected state, the partially connected state, and the connected state.

12. The multi-coupling component of claim 1, wherein the plurality of fluid couplers are standard ISO 16028 fluid couplers.

13. A multi-coupling system comprising:
a first multi-coupling component according to claim 1; and
a plurality of individual fluid couplers that are connectable to a portion of the plurality of fluid couplers and the case drain fluid coupler of the first multi-coupling component;
wherein the pressure relief mechanism is operable manually by hand to perform the pressure relief function to permit connecting the plurality of individual fluid couplers to the first multi-coupling component.

14. A multi-coupling system comprising:
a first multi-coupling component according to claim 1; and
a second multi-coupling component that is connectable to the first multi-coupling component and comprising a plurality of fluid couplers that are connectable to a portion of the plurality of fluid couplers and to the case drain of the first multi-coupling component.

15. The multi-coupling system of claim 14, wherein the second multi-coupling includes a driving region that automatically operates the pressure relief mechanism of the first multi-coupling component as the second multi-coupling component is connected to the first multi-coupling component.

16. The multi-coupling system of claim 14, wherein the first multi-coupling component is a fixed side coupling component that is fixed to a machine, and the second multi-coupling component is a mobile side coupling component that is movable relative to the first multi-coupling component to connect the second multi-coupling to the first multi-coupling component.

17. The multi-coupling system of claim 14, wherein one of the fluid couplers of the second multi-coupling component is a pressure relieving fluid coupler that manages pressure associated with fluid flow through the multi-coupling system

18. The multi-coupling system of claim 17, wherein the pressure relieving fluid coupler is a male fluid coupler that connects to a female fluid coupler of the first multi-coupling component.

19. (canceled)
